(19) United States
(12) Patent Application Publication
(10) Pub. No.: US 2004/0236623 A1
(43) Pub. Date: Nov. 25, 2004

(54) Methods and systems for constructing and maintaining sample panels

(76) Inventor: Vijoy Gopalakrishnan, Ellicott City, MD (US)

Correspondence Address: Eugene L. Flanagan III, Cowan, Liebowwitz & Latman, P.C., 1133 Avenue of the Americas, New York, NY, 10036-6799, US

(21) Appl. No.: 10/442,206

(22) Filed: May 20, 2003

(51) Int. Cl. G06F 17/60

(52) U.S. Cl. 705/10

(57) ABSTRACT

Methods and systems are provided for the dynamic management of a sample panel, the sample panel reflecting an audience population in terms of a geo-demographic composition thereof. Back-out data is provided representing forecasted back-outs of members of the sample panel according to their geo-demographic characteristics. In certain embodiments members are added to and/or removed from the panel based on the back-out data. In other embodiments adjustment data is produced indicating that members should be added to and/or removed from the sample panel based on the back-out data. In still other embodiments, potential panel members are selected from a sample pool for recruitment to the sample panel based on forecasted participation data.

### BACKGROUND OF THE INVENTION

The invention relates to methods and systems for constructing and maintaining sample panels subjected to dynamically changing parameters.

A prime commodity of the information society in which we live is timely, cost effective and accurate data and numerous entities require such data in order to operate. However, running a census for every informational need is usually not timely and/or cost effective for most entities. Therefore, information researchers from various fields such as governmental research, political polling, audience research, product marketing, medical research and the like, have all developed or use survey techniques to model a given population because collecting a full data set for most populations would be economically unfeasible, not timely and/or physically impossible, e.g. because of a population dispersed over a wide geographic area or due to the refusal of population members to participate in the survey.

Accordingly, the information research community has developed statistical methods to promote a level of accuracy that is reliable for surveys generated from scientifically chosen sample populations. Thus, to be a reputable information research firm, the information research firm must adhere to standardized procedures developed by the information research community.

The accepted standardized statistical procedures of the information research community thus form an operational framework for information research entities. Using accepted research practices, surveys can be constructed by using data collected via in-person interviews, mail surveys, automated recordation, telephone interviews, records surveys and the like as well as combinations of the foregoing and each data collection technique has its strength and weakness.

For example, a mail survey can be relatively inexpensive to use for data collection but can provide stale data for time sensitive survey subjects. On the other hand, telephone interviews can provide timely data but generally are inefficient at collecting data for a survey that can operate over a long period of time, while in-person interviews can produce complex data but are generally costly to operate.

As a result, information researchers have tried to combine the different data collection techniques thereby attempting to maximize each technique's strength while minimizing each technique's weakness. The combining of data collection techniques has met with only moderate success because the inherent strength and weakness of each data collection technique has not been overcome and combining data collection techniques has produced only a small incremental improvement in data collection.

Such limitations of existing data collection techniques and combinations of data collection techniques are further exacerbated when attempting to model a population over a longer period of time by means of a panel, because the panel members do change their minds and can decide to no longer participate as panel members. In addition, other parameters can change over time, e.g. the demographic composition of the target population. As a result, panels that are subject to dynamically changing parameters are very difficult to construct and maintain in a timely, cost-effective and accurate manner.

For example, existing techniques used to construct and maintain panels subjected to dynamically changing parameters over time have a limited ability to anticipate and adapt for panel member withdrawal. The methods currently used to deal with panelist back-out range from increasing the incentive for the panelist to remain on the panel to replacement of the panelist after withdrawal.

The first method of increasing the incentive to the panelist to continue participating adds cost to the operation of the survey as well as possibly improperly biasing the panelist. The second method of reactively replacing the panelist leaves a vacancy in the panel for a period of time, so that the panel is unbalanced until the panelist is replaced. This can distort the survey data. If a sample pool is used for replacing such lost panelists, a vacancy still exists for some period of time.

Consequently, what is needed is an intelligent system that can maintain balanced sample panels on a continuous basis despite dynamically changing influences.

### OBJECTS AND SUMMARY OF THE INVENTION

For this application the following terms and definitions shall apply, both for the singular and plural forms of nouns and for all verb tenses:

The term “data” as used herein means any indicia, signals, marks, domains, symbols, symbol sets, representations, and any other physical form or forms representing information, whether permanent or temporary, whether visible, audible, acoustic, electric, magnetic, electromagnetic, or otherwise manifested. The term “data” as used to represent particular information in one physical form shall be deemed to encompass any and all representations of the same particular information in a different physical form or forms.

The term “processor” as used herein means data processing devices, apparatus, programs, circuits, systems, and subsystems, whether implemented in hardware, software, or both, and whether used to process data in analog or digital form.

The term “network” as used herein means networks of all kinds, including both intra-networks and inter-networks, including, but not limited to, the Internet, and is not limited to any particular such network.

The term “geo-demographic” as used herein refers to geographic and/or demographic characteristics of sample panel members, potential sample panel members and/or audience populations in general.

In accordance with an aspect of the present invention, a method is provided for the dynamic management of a sample panel, the sample panel reflecting an audience population in terms of a demographic composition thereof. The method comprises providing back-out data representing forecasted back-outs of members of the sample panel according to their geo-demographic characteristics; and adding and/or removing members to the sample panel based on the back-out data.

In accordance with a further aspect of the present invention, a system is provided for use in the dynamic management of a sample panel, the sample panel reflecting an audience population in terms of a geo-demographic composition thereof, the system comprising means for providing back-out data representing forecasted back-outs of members of the sample panel according to their geo-demographic characteristics; and means for producing adjustment data for indicating that members should be added to and/or removed from the sample panel based on the back-out data.

In accordance with still another aspect of the present invention, a method is provided for selecting potential sample panel members for recruitment. The method comprises providing data representing a sample pool of potential sample panel members, producing forecasted participation data representing a forecast of potential sample panel members in the sample panel according to geo-demographic characteristics thereof, and selecting data representing potential sample panel members from the sample pool based on the forecasted participation data.

In accordance with still further aspect of the present invention, a system is provided for selecting potential sample panel members for recruitment. The system comprises means for providing data representing a sample pool of potential sample panel members, means for producing forecasted participated data representing a forecast of potential sample panel members in the sample panel according to geo-demographic characteristics thereof, and means for selecting data representing potential sample panel members from the sample pool based on the forecasted participation data.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a functional block diagram illustrating a system for constructing and maintaining sample panels subjected to dynamically changing parameters;

FIG. 2 is a flowchart illustrating a process for establishing and updating operational concerns according to the system of FIG. 1;

FIG. 3 is a flowchart illustrating a process for establishing and updating a sample panel forecasted participation model according to the system of FIG. 1;

FIG. 4 is a flowchart illustrating a process for monitoring and collecting output from a sample panel according to the system of FIG. 1; and

FIG. 5 is a flowchart of a process for selecting potential panel members for recruitment according to the system of FIG. 1.

### DETAILED DESCRIPTION OF THE CERTAIN ADVANTAGEOUS EMBODIMENTS

The present invention relates to methods and systems for constructing and maintaining sample panels subjected to dynamically changing parameters such as operational concerns, geo-demographic considerations and the like. A sample pool is a collection of potential panel sample members who have completed the interview process to be categorized or enumerated. A sample panel is a set of panel members that were selected from one or more sample pools and agreed to be part of the panel. Operational concerns include, but are not limited to, addition/subtraction of geo-demographics, research methodology changes, performance variance of the various operational entities such as interviewing, panel relations and sample quality. Geo-demographic considerations include, but are not limited to, changes in the universe being sampled, seasonal changes in different segments of the universe being sampled and withdrawal of participants from the panel.

In certain embodiments of the invention, the operational concerns and/or demographic considerations are adjusted to ensure a stratified sampling process that is as statistically rigorous as possible and to provide a sample that at the operational level can deliver a sample panel which is representative within the stated goals. Operationally, this involves over-selecting classes that are under-represented in the panel and under-selecting or eliminating certain classes within control variables that are over-represented, or no longer significant or valid in the panel. More importantly, the selection, de-selection, balancing and maintenance factors of the panel are forecasted and acted upon proactively thereby allowing the invention to adjust prior to a limiting or debilitating problem with the panel.

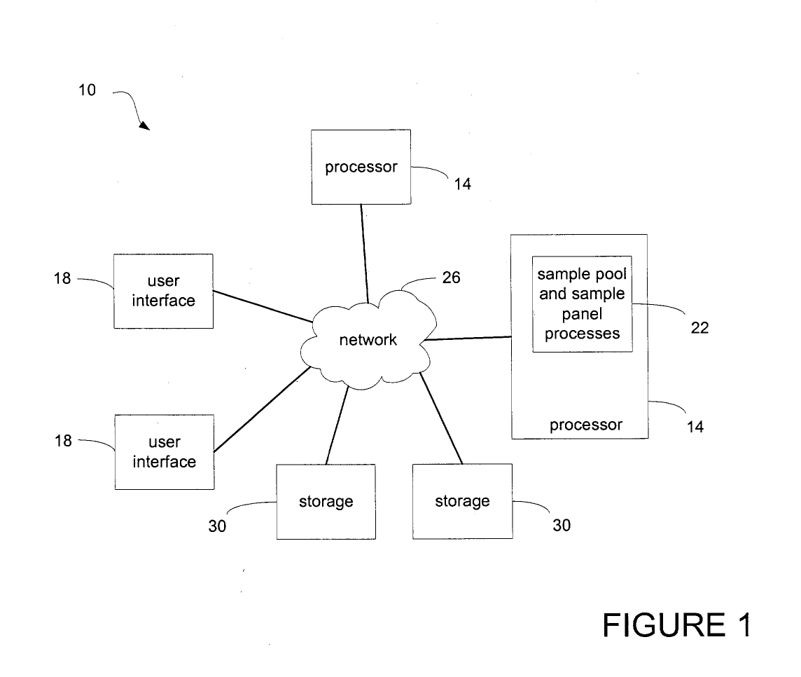

FIG. 1 is a block diagram of a system 10 in accordance with an embodiment of the invention that includes at least one processor 14 having executing thereon sample panel processes 22. Sample panel processes 22 include establishing, maintaining and updating sample pools and panels, determining operational concerns, establishing, maintaining and updating forecasted participation models for the sample panel and monitoring, maintaining and collecting output from the sample panel. System 10 also includes at least one storage 30 accessible by processor 14 for the storage of the survey parameters and data entered and/or produced by system 10. System 10 further includes at least one user interface 18 which enables a user to input data into system 10 as well as retrieve output data from system 10, e.g. display screen, printer, mouse, keyboard, stylus, speakers, optical scanner, floppy drive, disc drive, microphone and/or the like.

User interface 18 is in communication with processor 14 via network 26. Network 26 can be a hard wired and/or wireless network, e.g. employing parallel cable, serial cable, coaxial cable, twisted wire pair, USB cable, infrared link, radio frequency link, microwave link, satellite link and the like. In the alternative, user interface 18 may be connected directly to processor 14.

A user of system 10 can be a system administrator as well as any other authorized entity who has been given access rights to system 10. Multiple users can utilize the system through the use of user profiles and sample panel profiles that can segregate data, permissions and authorizations accordingly and therefore user profiles control access to system 10 and sample panel profiles control access to sample panel data stored on storage 30.

For example, a user of system 10 may have one informational need while an alternative user may have a different and unrelated informational need. Each user can access system 10 independently of the other and utilize system 10 to fulfill their informational needs. Each user of system 10 would begin by defining an informational need in terms of what universe they would like to model.

System 10 initiates when a universe estimate is generated using standard statistical methods utilizing universe data that is considered accurate and readily available, e.g. United States census data. The user can use the universe estimate to identify what members of the population being studied need to be located or covered by the sample frame so that each particular class that is required by the user's informational need within the population has an equal chance of being sampled.

For instance, an information researcher may want to know how many adults are employed in a household and what their ages are and this information may be utilized in similar or different ways by different information researchers depending on what the particular goals of the information researcher are. Not only can different information researchers have different requirements but they can face different operating constraints represented by a resource budget that is affected by different operational concerns.

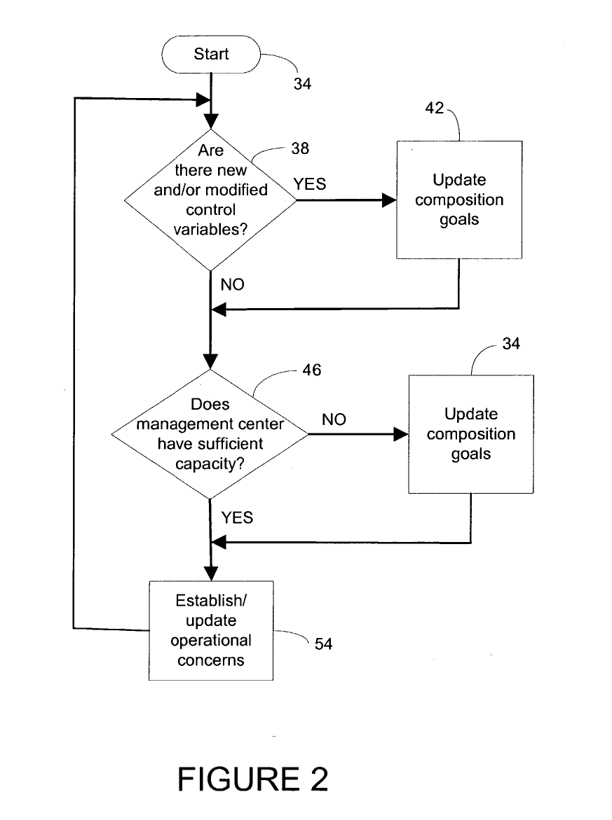

Referring now to FIG. 2, operational concerns are business considerations that impact the ability to construct and/or maintain a panel whereby a budgeting of available resources needs to be determined. As was described in the background section of this application, there will always be constraints on what resources are available for these purposes and how those resources will be utilized, since otherwise a complete census would be performed. Operational concerns include, but are not limited to at least three major concerns such as addition/subtraction of geo-demographics, research methodology changes, performance variance of the various operational entities such as interviewing, panel relations and sample quality.

First, addition/subtraction of geo-demographics can occur where an informational researcher is trying to limit the model to only required classes of possible participants and/or data points. System 10 will address this question in block 38 by checking to see if there are new and/or modified control variables with a control variable being a particular enumeration or categorization of potential participants.

For instance, in the aforementioned example of an information researcher wanting to know how many adults are employed in a household and their ages would be information used by both media market researchers and economists. Therefore, in the interest of conserving resources, the economist would find this data set sufficient while the media market researcher would probably find it necessary to also find out how many television sets are in each household. System 10 serves to add and/or subtract geo-demographics or composition goals, such as geo-demographic goals, without corrupting existing data gathered through the panel, as indicated in block 42 of FIG. 2.

Second, research methodology changes can occur, for example, where the information research community recommends a new statistical technique that promotes more accurate or faster production of data. Accordingly, the operational resource capability to contact, recruit and follow up with potential panel members, can be affected by the implementation of such research methodology changes. System 10 assess the consequent changes in the operational resource capabilities and, as indicated at 50, updates the composition goals based on the reassessed operational resource capabilities.

And thirdly, the various operational entities within the panel management center such as interviewing, panel relations and sample quality have performance capabilities that vary over time due to absences for various reasons as well as variability in experience levels, breakdowns in communications systems and weather-related problems. Interviewing entities are the groups that are tasked with contacting the potential panel members, inquiring if the contacted person would like to participate in the panel and questioning the potential member so that they can be categorized according to their attributes to produce an enumerated sample. System 10 checks to see if the management center has sufficient capacity to meet the requirements of the panel parameters, block 46, e.g., does the management center have the resources to meet system 10's demands?

Panel relations, a branch of the management center, block 46, refers to the group tasked with getting the participants connected to the panel data collection system and retaining them. In certain embodiments, system 10 provides a self-install kit delivered to each panel member for installation of data collection equipment or software and the panel relations group is available to the members to resolve any installation issues that they may have. In an alternative embodiment, the system can be installed by the information researcher seeking the data, however this method is generally not as cost effective and expedient as allowing each panelist to self-install. Panel relations also is tasked with investigating why a participant is no longer participating or why the participants want to withdraw from the panel.

Each branch of the management center can have complications that can impede the flow of potential panel members into the panel, such as communication problems, e.g. the telephone company having a switching unit accidentally going down, and/or weather problems, e.g. a blizzard or a hurricane can impact the management center's ability to supply system 10 with an adequate number of participants. To cope with such management center limitations, system 10 can update the targets that are required from the management center thereby compensating for the external constraints imposed on it without impacting the accuracy of the data produced by the panel.

For example, suppose that the panel relations entity was limited by a communications problem as was discussed above. System 10 would adjust the goals required of the panel relations entity in a manner that would not compromise the data obtained from the panel, block 50. Likewise, suppose the interviewing center was experiencing a winter storm that was limiting the number of interviewers that could make it to work. Again, system 10 would update the survey panel recruitment goals according to the interviewing center's capacities and system 10's requirements, block 50, without adversely impacting sample quality. Sample quality refers to the ability of the sample to accurately reflect the universe that it is attempting to model within a specified range.

Nevertheless, data collected by the panel can be said to represent a truthful estimate of the target population calculated within a certain degree of accuracy. This degree of accuracy can be improved in some cases by increasing the size of the sample or updating the universe estimate and/or the enumerated classes within the universe more frequently. Consequently, tradeoffs can be made between cost and accuracy. Again, system 10 can adapt to these changes as necessity demands without corrupting the data.

Therefore, addressing operational concerns that define the resource budget for system 10 while limiting the adverse impact on sample quality is an important feature of system 10. System 10 iteratively checks the operational concerns and updates them after the operational concerns are established, block 54, because change is inevitable in most panel environments.

In certain embodiments of the present invention a forecasted participation model is developed and employed to predict the likelihoods that individuals and/or households within each enumerated class, can be recruited successfully to participate in the panel. The forecasted participation model comprises forecasts of numbers of potential participants within the various enumerated classes who must be contacted, recruited and/or followed up in order to achieve a statistically balanced sample pool. These forecasts provide system 10 with a dynamic assessment of operational requirements to achieve the goals of the informational researcher while operating within the operational capabilities of the survey organization.

For example, seasonality can cause a model of a population to fluctuate between being within the accepted range and outside the accepted range depending on the season in which the survey data is collected, e.g. data collected from households with 2 or more children is within range during the school year, but may be outside the range during summer break because these households have a tendency to go on vacation during the summer break thereby affecting the survey data for this group.

Another example of how parameters change over time and therefore affect system 10's accuracy is a change in the enumeration category for a particular participant, e.g., a participant's household of 3 may become a household of 4 and a household with 2 employed adults may become a household with 1 employed adult.

In the aforementioned examples of parameter changes, system 10 will compensate for such changes in order for the enumerated classes of the sample panel to stay within the ranges defined by the information researcher. In certain embodiments, system 10 compensates by adjusting the forecast or forecasts for one or more of the enumerated classes.

Once the assessment of the influence of the parameters is made, system 10 establishes or updates the forecasted participation model accordingly. In accordance with one aspect of the invention, different back-out data are produced for the sample panel forecasted participation model such as forecasted data for pre-install back-outs, post-install back-outs, and the like.

A back-out is a potential panel participant that has consented to participate in the panel and then withdraws their consent. For example, a pre-install back-out is a potential panel participant who consented during the initial contact and was enumerated for the sample pool but when contacted after being randomly selected from the sample pool, declined to join the sample panel. A post-install back-out is a potential panel participant who was randomly selected from the sample pool, agreed to participate and installed, but later backed out. In each case the back-out data indicates a likelihood of back-outs.

In all of these cases, the forecasted participation model will generate participation rates based on the back-out data for each enumerated category during different points in time or stages of panel recruitment, e.g. consenting or refusing to join the panel, consenting to installing the survey monitoring system, participation after installing the monitoring gear and the like. The back-out data are produced using historical data averages, trend estimates of historical data and other standard statistical techniques.

For instance, system 10 will utilize the universe estimate to generate a minimum and maximum range for an enumerated category, e.g. 100 “purple” participants with a margin of error of ±3% and therefore a range of 97-103 purple participants. System 10 then utilizes the forecasted participation model to see what is necessary to maintain the purple participants' range for the panel based on the recruitment yield representing the number of potential participants who were randomly selected and agreed to participate and current composition of the sample panel to predict how many purple participants must be added or removed, if any, to maintain the purple participants within the required range and system 10 will do this for all enumerated categories.

System 10 utilizes the back-out data (which may also be expressed as its inverse or compliment participation data) in conjunction with the universe estimate and operational concerns to create a resource budget. System 10 then dynamically applies the resource budget to the demands of the survey as defined by the information researcher thereby adapting the survey to accommodate changes that occur in all surveys.

System 10 also utilizes install success rate data by class and current installs by class, as well as recruitment yield by class to formulate the forecasted participation model.

Once the forecasted participation model for the sample panel is established, the enumerated sample pool in certain embodiments is partitioned and sorted in ascending order of the variables that may need to be controlled and a random start and sampling interval are selected.

The potential sample panel participants are then selected using systematic sampling procedures to select them from the sample pool. Due to the nature of systematic sampling, the sample panel target for the designated classes is not always achieved exactly but the results are well within the bounds of system 10's operational margin of error. This selection procedure for choosing sample panel participants utilizes techniques that are among those that a person skilled in the art would employ. If system 10 is within its operational range, then the sample panel can be adjusted according to the needs reflected by the sample panel forecasted participation model, block 90.

For example, if the sample panel is four participants under on the required amount of “purple” participants but within range, then system 10 can continue to try to add purple participants to the sample panel to achieve its near optimal configuration. Alternatively, suppose the sample panel is one “blue” participant over on the required amount of blue participants but the system forecasts that a blue participant will withdraw from the survey this week. In this situation, system 10 can maintain the current number of blue participants and allow natural attrition to pull system 10 back to its nearly optimal configuration.

If the sample pool is not within range, then system 10 checks to see if the forecasted participation model is up-to-date. If the forecasted participation model is up-to-date, then system 10 can add and/or subtract survey participants according to the survey's needs. However, in certain embodiments, system 10 does not optimize each enumerated category proactively but rather utilizes natural attrition for this purpose to further conserve resources.

For instance, suppose system 10 is 11 purple participants over the panel's nearly optimal requirement but system 10 also recognizes that 4 purple participants are likely to leave the panel by natural attrition. The information researcher defining system 10's operational constraints may deem 5 participants over within the operational range. Consequently, it is advantageous in this circumstance to remove only 2 purple participants, as this will bring the number of this enumerated class within range and ultimately conserve resources, since natural attrition will further reduce this number without further action by the survey organization.

If the forecasted participation model is not up-to-date, then system 10 updates the forecasted participation model, as explained above. The process of monitoring the sample panel and the potential members or participants is an iterative one that proceeds according to the requirements of the information researcher and the forecasted participation model. The forecasted participation model can present the minimum and maximum necessary for system 10 to stay within the operational range of the sample pool whereas the information researcher has to decide, at some point, what range system 10 utilizes although the information researcher can modify the range as necessity or desire dictates.

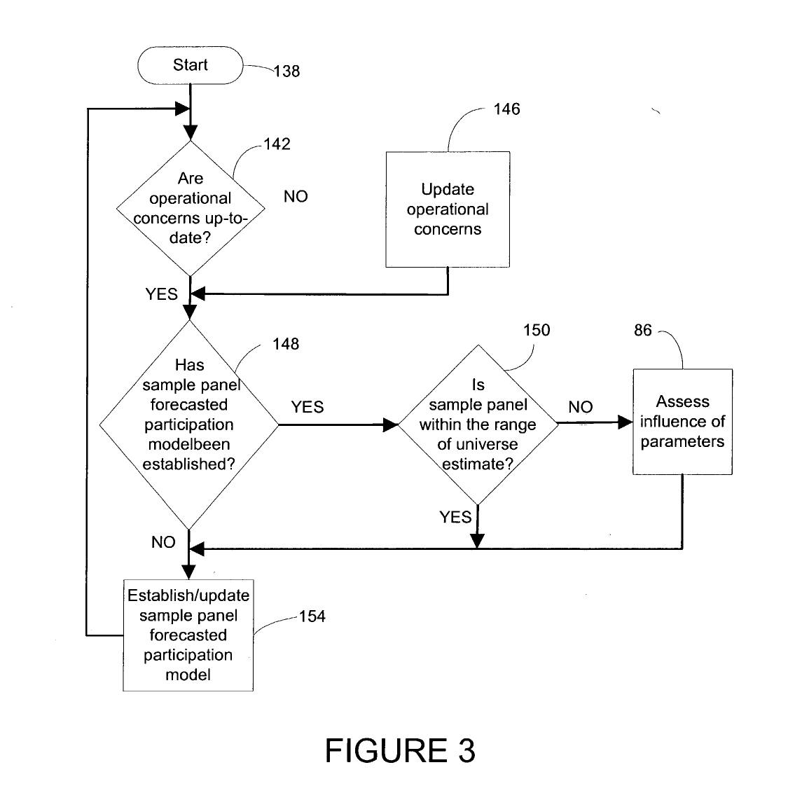

Referring now to FIG. 3, a forecasted participation model for the sample panel is produced, which will provide the projected resource needs of system 10 for the sample panel. To achieve this, system 10 checks to see if the operational concerns are up-to-date in block 142. Operational concerns are updated in block 146 if they are out-of-date and system 10 then checks to see if a sample panel forecasted participation model has been established, block 148. If a sample panel forecasted participation model has not been established, then a sample panel forecasted participation model is established in block 154.

When the sample panel forecasted participation model has been established, then the sample panel checked to see if it is within the range of the universe estimate at block 150. If the sample panel is out of range, then system 10 assesses the influence of parameters such as seasonality and changes in enumeration categories and then establishes or updates the sample panel forecasted participation model. Thereafter, the sample panel is established or updated to bring it within the desired operational range based on the updated forecasted participation model.

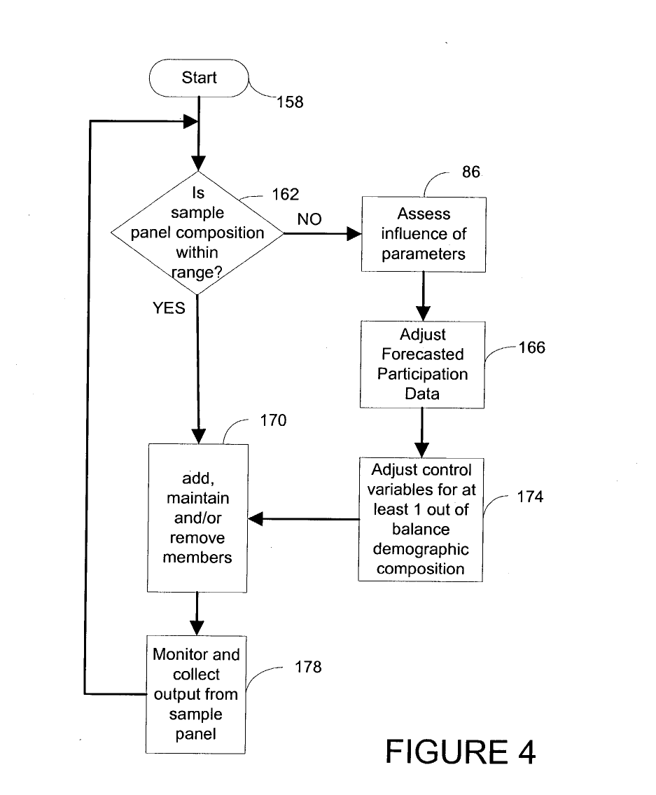

Referring now to FIG. 4, a sample panel is maintained and survey data is collected by system 10. To achieve this, system 10 has to check to see if the sample panel composition is within the desired range at block 162. The sample panel composition is the grouping of the various geo-demographic groups according to their percentage representation in the universe estimate and the range is the margin of error allowable for deviation from the optimal.

If the sample composition is not within the desired range, then system 10 assesses the influence of parameters as described above in conjunction with FIG. 3. System 10 then adjusts the sample panel forecasted participation model based on the assessed parameters, block 166. Because some enumerated groups can have a greater impact on the survey as a whole than other enumerated groups, system 10 in certain embodiments adjusts only one out-of-balance geo-demographic group that is particularly influential on the survey as a whole. However, in certain other embodiments, two or more of the out-of-balance geo-demographic groups having relatively greater impact on the survey are adjusted. Consequently, by adjusting only those influential enumerated groups that exert more influence on the survey as a whole permits system 10 to make the minimal amount of changes to the sample panel and still achieve a balancing effect on the sample panel.

System 10 then adds, maintains and/or removes members from the sample panel according to the needs of the survey, block 170, because system 10 is an adaptive system that dynamically adjusts to the changes experienced by system 10. These changes may be external, e.g. the weather affecting the interviewing center, internal, e.g. participants withdrawing from the survey, and/or administrative, e.g. information researcher demands a tighter margin of error. In all of these cases, change is the constant as in most near real-time modeling systems and system 10 has to adapt to the change. System 10 not only adapts to all the changes it experiences, it adapts proactively to such changes through the use of forecasting. System 10 will therefore output survey data from the sample panel to the information researcher that is monitored in an iterative fashion to ensure the closest possible correlation between the survey and the real universe for a given resource budget.

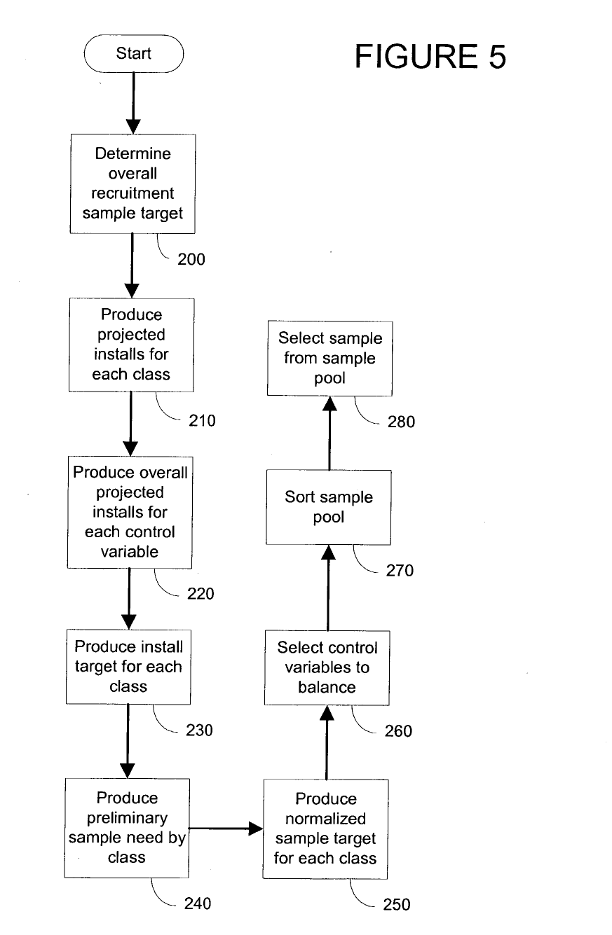

FIG. 5 illustrates a process for selecting potential panelists from a sample pool for participation in a sample panel, wherein those who agree to participate are provided with self-install kits of data gathering equipment and /or software to be installed by the participants. Preliminarily, an enumerated sample pool is established in accordance with standard statistical practices. In certain embodiments, the sample pool is a set of sampled households that have been contacted and enumerated by a research organization for possible participation in a media usage measurement panel, for example, for measuring usage of radio, television, Internet, or the like.

The process of FIG. 5 is carried out periodically, for example, daily, weekly, monthly, bi-weekly, etc., or from time to time to recruit from the sample pool to a sample panel. In block 200, overall recruitment sample target data is determined representing the total number of enumerated households that is planned to be selected on a particular day (in this example) to be sent to an interviewing center for recruitment to the panel. The overall recruitment sample target data is determined based upon operational concerns as described hereinabove, especially the capacity of the interviewing center.

Then in block 210, projected installs data is produced for each class within each control variable. The projected installs data represents a prediction of the number of households within each respective class within each control variable expected at a future time to be panel members (that is, agreed to participate and successfully installed the equipment and/or software). The projected installs data is produced as the sum of data (1) representing households it is estimated will be installed at a future date from those households previously selected from the sample pool and in the process of recruitment or queued for recruitment, data (2) representing those households that have agreed to participate in the panel and are expected to be installed in the future, and data (3) representing those households that currently are installed.

Data (1) is obtained as the product of the recruitment pipeline sample (enumerated households within the respective class selected from the sample pool and sent to the interviewing center for recruitment, but which have not yet been called or else are in the process of recruitment) and install yield data. The install yield data represents a projected proportion or percentage based on historical data of the recruitment pipeline sample for the respective class that is expected to be installed to participate in the panel. The install yield data, in turn, is obtained as the product of a recruitment agreed yield for the respective class (the proportion or percentage of the recruitment pipeline sample based on historical data that are expected to agree to participate in the panel) and an installation success rate (the proportion or percentage based on historical data of the households that agree to participate and that successfully install the equipment/software). The installation success rate is obtained as a ratio of successful self-installs to the sum of successful self-installs and pre-install back outs.

Data (2) is obtained as the product of (a) the households within the respective class that have already agreed to participate but for which the self-install kits have not yet been shipped, and (b) the installation success rate, as described above.

With reference to block 220, overall projected installs data for each control variable are produced, as a basis for producing install target data for each class within the control variable, as described below in connection with block 230. For each control variable, the overall projected installs data are produced as the sum of all of the projected installs data for each class within the control variable and data representing the number of households within those to be selected on that particular day that are forecasted to be installed. The latter data is produced as the product of the overall recruitment sample target data and overall install yield data representing a percentage or proportion of the overall recruitment sample target which it is expected will be installed. The overall install yield data is produced as a weighted average of the install yield data for all classes. Accordingly, the overall projected installs data for each control variable represents the total number of forecasted installs for all classes whether based on current installs, households that have agreed to participate and are expected to install successfully, and those households within the recruitment pipeline sample or within the overall recruitment sample target that are expected to agree and successfully install. It is noted that the overall projected installs data for each control variable should be substantially the same for all control variables.

As indicated above, in block 230 install target data is produced to represent a forecast of the number of installs within each class within each control variable from the overall recruitment sample target for that day. It is produced as the difference between (a) the product of the overall projected install data for the control variable and the universe estimate for that class, expressed as a value between zero and one, and (b) projected installs data for that class.

In order to translate the install target data into data representing the required sample for the class, referred to as the “preliminary sample need by class” in block 240, the install target data is divided by the install yield for the class. The preliminary sample need data by class, therefore, represents a forecasted sample required to balance the class in the future, without regard to operational concerns limiting the ability to provide samples on that particular day.

Accordingly, in order to distribute the overall sample target, which is limited by operational concerns, among the various classes based on their proportion to the total sample need, in block 250 data representing a normalized sample target for each class is produced as the product of the overall recruitment sample target data and a ratio of (a) the preliminary sample need data by class, and (b) the sum of all preliminary sample need data for all classes within the control variable.

For each class within each control variable, as indicated in block 260, the difference between its projected installs and its universe estimate is determined to assess the extent to which that class is forecast to be out of balance in the future, based only on its projected installs. Then the extent of such differences is assessed for each control variable, and one or more control variables are selected to receive priority in sampling, as described below, so that these control variables consequently receive priority for purposes of balancing them geo-demographically through installs resulting from the sample selected on that particular day. In certain embodiments, the control variables are selected in descending order of importance from the control variable which is most out of balance towards that which is least out of balance. In certain ones of these embodiments, either the top two or three control variables are selected, in order from the top.

However, in certain embodiments two or more control variables may be highly correlated. For example, for a television media usage measurement panel it may be found that a control variable based on the number of adults in a household employed full time is correlated to household size. In such embodiments, the more influential control variable of the two is selected and the other is not, since balancing the first will very likely bring the second into balance automatically.

With reference to block 270, the enumerated sample pool is sorted in the order of the selected control variables. In certain embodiments, the household records are contained in an electronic spreadsheet in which each row is a separate record and each column contains the class value of a respective control variable. The first control variable in the order determined in block 260 is selected first for sorting the household records, followed by the second, if any, and so on, until the household records have been sorted in descending or ascending order for all such selected control variables.

Then, with reference to block 280, the household records are selected for the sorted sample pool in accordance with standard statistical practice. For example, in certain embodiments a random start and sampling interval are produced and the household records are selected from the sorted sample pool using these values until a number of records equal to the overall recruitment sample target has been selected.

Although illustrative embodiments of the present invention and modifications thereof have been described in detail herein, it is to be understood that this invention is not limited to these precise embodiments and modifications, and that other modifications and variations may be effected therein by one skilled in the art without departing from the scope and spirit of the invention as defined by the appended claims.

What is claimed is:

1. A method for the dynamic management of a sample panel, the sample panel reflecting an audience population in terms of a geo-demographic composition thereof, the method comprising:
providing back-out data representing forecasted back-outs of members of the sample panel according to their geo-demographic characteristics; and
adding and/or removing members to the sample panel based on the back-out data.

2. The method of claim 1, comprising:
providing panel composition data representing a geo-demographic composition of the sample panel;
wherein adding members to the sample panel comprises adding members thereto based on the panel composition data.

3. The method of claim 1, comprising:
providing demographic data representing the geo-demographic composition of the audience population; and
establishing the sample panel based on the geo-demographic data.

4. The method of claim 1, comprising:
establishing the sample panel by adding members thereto from time to time such that the sample panel reflects an estimated audience population over time.

5. The method of claim 1, comprising:
deriving performance eccentricities of sample panel geo-demographic characteristics data by comparing present sample panel geo-demographic characteristics data to past sample panel geo-demographic characteristics data; and
adapting the forecasted back-outs of members of the sample panel based on the performance eccentricities of the sample panel geo-demographic characteristics data.

6. The method of claim 1, comprising:
providing an added sample panel member with a self-install kit enabling the added sample panel member to install equipment necessary for participation in the sample panel.

7. The method of claim 2, comprising:
balancing a geo-demographic composition of the sample panel by controlling data representing at least one out-of-balance geo-demographic composition of the sample panel composition.

8. The method of claim 1, wherein a survey organization establishes the sample panel, the method comprising:
utilizing data representing survey organization capabilities in the determination of the forecasted participation data for the sample panel.

9. The method of claim 8,
wherein the data representing survey organization capabilities comprises data representing sample panel recruitment capabilities.

10. The method of claim 8,
wherein the data representing survey organization capabilities comprises data representing sample panel installation capabilities.

11. The method of claim 1, comprising:
utilizing data representing sample panel performance capabilities in the determination of the forecasted participation data for the sample panel.

12. A system for use in the dynamic management of a sample panel, the sample panel reflecting an audience population in terms of a geo-demographic composition thereof, the system comprising:
means for providing back-out data representing forecasted back-outs of members of the sample panel according to their geo-demographic characteristics; and
means for producing adjustment data for indicating that members should be added to and/or removed from the sample panel based on the back-out data.

13. The system of claim 12, comprising:
means for providing panel composition data representing a geo-demographic composition of the sample panel;
wherein the means for producing adjustment data is operative to produce the adjustment data based on the panel composition data.

14. The system of claim 12, comprising:
means for providing geo-demographic data representing the geo-demographic composition of the audience population;
wherein the means for producing adjustment data is operative to produce the adjustment data based on the geo-demographic data.

15. The system of claim 12, comprising:
means for deriving performance eccentricities of sample panel geo-demographic characteristics data by comparing present sample panel geo-demographic characteristics data to past sample panel geo-demographic characteristics data; and
wherein the means for providing back-out data is operative to adapt the forecasted back-outs of members of the sample panel based on the performance eccentricities of the sample panel geo-demographic characteristics data.

16. The system of claim 13, comprising:
means for balancing a geo-demographic composition of the sample panel by controlling data representing at least one out-of-balance geo-demographic composition of the sample panel composition.

17. The system of claim 12,
wherein the means for producing adjustment data is operative to produce the adjustment data based on data representing survey organization capabilities.

18. The system of claim 17,
wherein the means for producing adjustment data is operative to produce the adjustment data based on data representing sample panel recruitment capabilities.

19. The system of claim 17,
wherein the means for producing adjustment data is operative to produce the adjustment data based on data representing sample panel installation capabilities.

20. The system of claim 12, comprising:
means for utilizing data representing sample panel performance capabilities in the determination of the forecasted participation data for the sample panel.

21. A method of selecting potential sample panel members for recruitment, comprising:
providing data representing a sample pool of potential sample panel members;
producing forecasted participation data representing a forecast of potential sample panel members in the sample panel according to geo-demographic characteristics thereof; and
selecting data representing potential sample panel members from the sample pool based on the forecasted participation data.

22. A system for selecting potential sample panel members for recruitment, comprising:
means for providing data representing a sample pool of potential sample panel members;
means for producing forecasted participation data representing a forecast of potential sample panel members in the sample panel according to geo-demographic characteristics thereof; and
means for selecting data representing potential sample panel members from the sample pool based on the forecasted participation data.
